(19) United States
(12) Patent Application Publication
(10) Pub. No.: US 2026/0144313 A1
(43) Pub. Date: May 28, 2026

(54) FLUID FINGER PROTECTION DEVICE

(71) Applicant: William Jackson, Kingston, TN (US)

(72) Inventor: William Jackson, Kingston, TN (US)

(21) Appl. No.: 18/962,968

(22) Filed: Nov. 27, 2024

(51) Int. Cl. A41D 13/08; G10D 3/173

(52) U.S. Cl. CPC A41D 13/087; G10D 3/173

(57) ABSTRACT

A fluid finger protection device for forming an artificial callus on fingertips of a user includes a bottle and a fluid finger treatment contained in the bottle which can be applied to the user's fingertips. The fluid finger treatment comprises hardens when the fluid finger treatment is exposed to air such that the fluid finger treatment forms an artificial callus on the user's fingertips for reducing discomfort associated with playing the stringed instrument. A cap is removably attachable to the neck of the bottle and a stem extends downwardly from the cap. A plurality of bristles is each coupled to the stem to apply the fluid finger treatment to the user's fingertips when the user removes the cap from the neck of the bottle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable.

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to finger protection device and more particularly pertains to a new finger protection device for forming an artificial callus on fingertips of a user. The device includes a bottle and a fluid finger treatment contained in the bottle which hardens into an artificial callus when the fluid finger treatment is applied to the user's fingertips. The device includes a cap that is removably attachable to the bottle and a stem attached to the cap and a plurality of bristles attached to the stem for applying the fluid finger treatment to the user's fingertips.

### (2) Description of Related Art Including Information Disclosed Under 37 CFR 1.97 and 1.98

The prior art relates to finger protection devices including: a variety of finger shield devices that each at least includes a solid sleeve that is positionable over a fingertip of a user to protect the user's fingertip; a variety of liquid bandage coating devices that each at least includes a liquid finger treatment that can be applied to skin of a user to which dries into a film to serve as a wound treatment. In no instance does the prior art disclose a fluid finger treatment device that includes a bottle and a fluid finger treatment contained in the bottle which cures into an artificial callus on a user's fingertips to reduce discomfort associated with playing a stringed instrument and a cap and a stem attached to the cap and a plurality of bristles attached to the stem for applying the fluid finger treatment to the user's fingertips.

### BRIEF SUMMARY OF THE INVENTION

An embodiment of the disclosure meets the needs presented above by generally comprising a bottle and a fluid finger treatment contained in the bottle which can be applied to a user's fingertips. The fluid finger treatment comprises hardens when the fluid finger treatment is exposed to air such that the fluid finger treatment forms an artificial callus on the user's fingertips for reducing discomfort associated with playing the stringed instrument. A cap is removably attachable to the neck of the bottle and a stem extends downwardly from the cap. A plurality of bristles is each coupled to the stem to apply the fluid finger treatment to the user's fingertips when the user removes the cap from the neck of the bottle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of a fluid finger protection device according to an embodiment of the disclosure.

FIG. 2 is a an exploded perspective view of an embodiment of the disclosure.

FIG. 3 is a perspective in-use view of an embodiment of the disclosure showing a fluid finger treatment being applied to a user's fingertips.

FIG. 4 is a perspective in-use view of an embodiment of the disclosure showing a user playing a stringed instrument.

FIG. 5 is a perspective in-use view of an embodiment of the disclosure showing a user employing an alcohol wipe to dissolve an artificial callus on a user's fingertips.

### DETAILED DESCRIPTION OF THE INVENTION

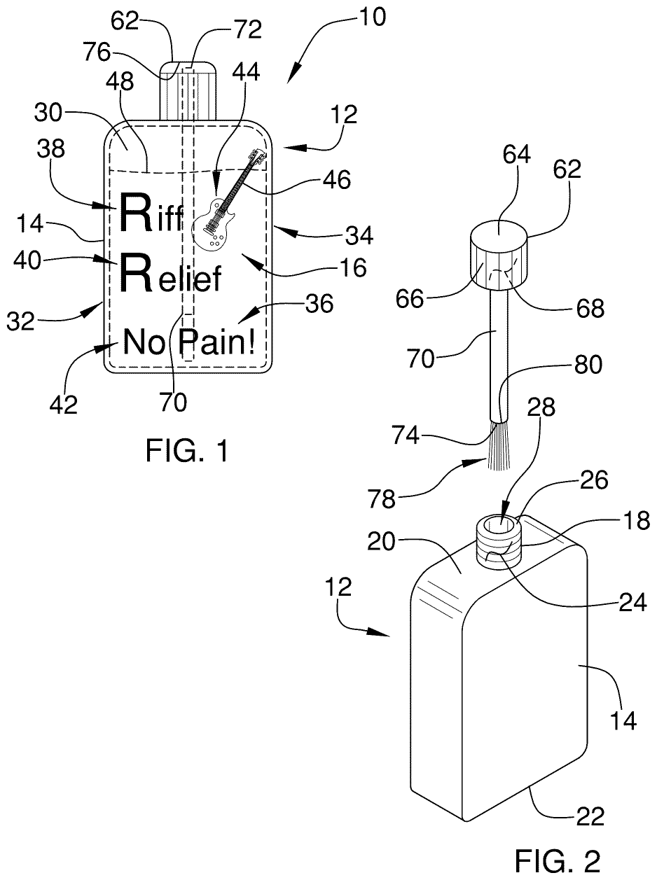

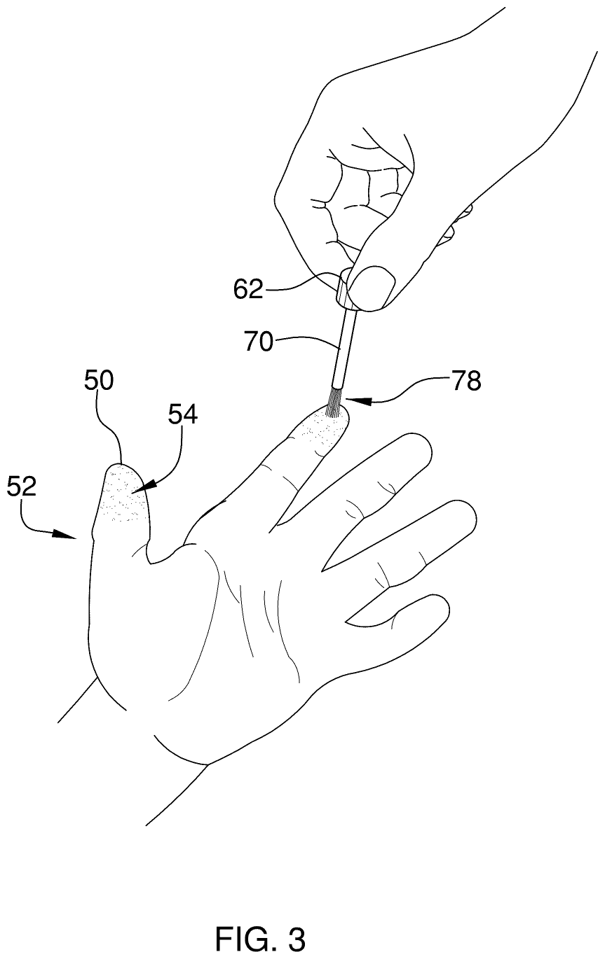

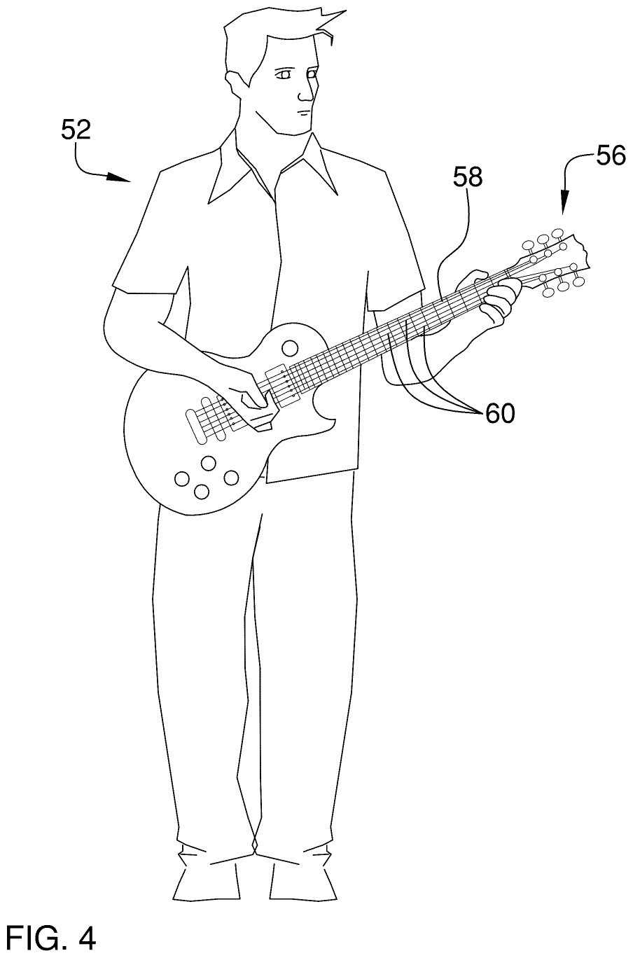

With reference now to the drawings, and in particular to FIGS. 1 through 5 thereof, a new finger protection device embodying the principles and concepts of an embodiment of the disclosure and generally designated by the reference numeral 10 will be described.

As best illustrated in FIGS. 1 through 5, the fluid finger protection device 10 generally comprises a bottle 12 that has an outer wall 14 defining an interior space 16 of bottle 12 and the bottle 12 has a neck 18 which is in fluid communication with the interior space 16. The outer wall 14 extends between a top wall 20 of the bottle 12 and a bottom wall 22 of the bottle 12 and the neck 18 extends upwardly from the top wall 20. The neck 18 has an outer surface 24 which is threaded and the neck 18 has a top end 26; the neck 18 has an opening 28 extending through the top end 26 and into the interior space 16. Furthermore, the bottle 12 may have a fluid volume ranging between approximately 175.0 ml and 300.0 ml.

The outer wall 14 has a front side 30 and a first lateral side 32 and a second lateral side 34 and word indicia 36 are applied to the front side 30 of the outer wall 14. The word indicia 36 comprise the words “Riff” 38 and “Relief” 40 and “No Pain!” 42. Furthermore, the word “Riff” 38 is positioned between the top wall 20 and the bottom wall 22 and the word “Riff” 38 is positioned closer to the first lateral side 32 than the second lateral side 34. The word “Relief” 40 is positioned between the word “Riff” 38 and the bottom wall 22 and the word “Relief” 40 is positioned closer to the first lateral side 32 than the second lateral side 34. Additionally, the words “No Pain!” 42 are positioned between the word “Relief” 40 and the bottom wall 22 and the words “No Pain!” 42 are centrally located between first lateral side 32 and the second lateral side 34. Image indicia 44 are applied to the front side 30 of the outer wall 14 and the image indicia 44 comprise an image of an electric guitar 46. Additionally, the image indicia 44 are positioned between the word “Riff” 38 and the second lateral side 34 of the outer wall 14.

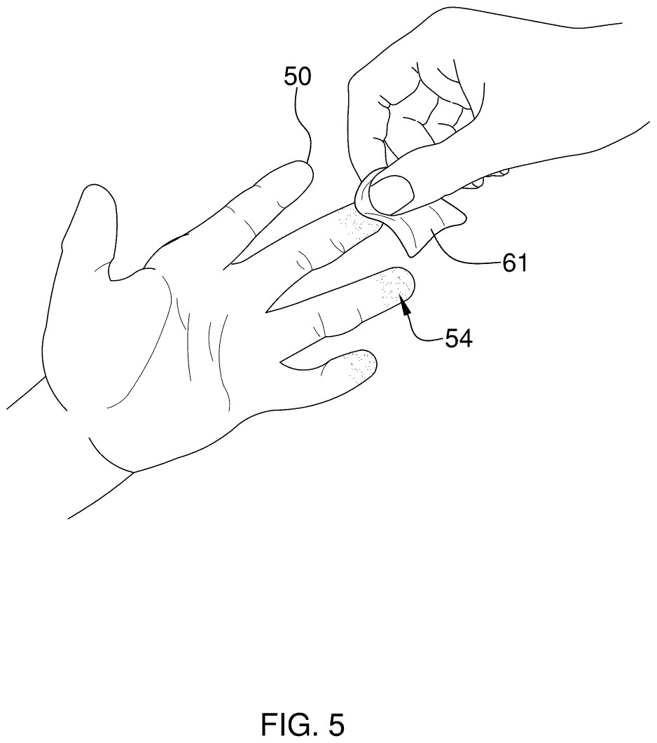

A fluid finger treatment 48 is contained in the interior space 16 of the bottle 12 and the fluid finger treatment 48 can be applied to fingertips 50 of a user 52. The fluid finger treatment 48 comprises a curing solution, including but not being limited to a rosin modified ester resin, an alcohol soluble rosin resin or other type of medical grade adhesive which is non-toxic on human skin and which hardens when the fluid finger treatment 48 is exposed to air. Furthermore, the fluid finger treatment 48 forms an artificial callus 54 on the user's fingertips 50 when the fluid finger treatment 48 is applied to the user's fingertips 50 for reducing discomfort associated with playing a stringed instrument 56. The stringed instrument 56 may be a guitar or a violin or any other stringed instrument that has a fretboard 58 and strings 60 that are depressed onto the fretboard 58 while the stringed instrument 56 is being played. The fluid finger treatment 48 comprises an alcohol soluble material, including but not being limited a polyamide resin, such that the fluid finger treatment 48 dissolves when the fluid finger treatment 48 is exposed to alcohol. Furthermore, as is shown in FIG. 5, the fluid finger treatment 48 can be removed from the user's fingertips 50 when the user 52 applies alcohol to their fingertips 50 with an alcohol wipe 61, for example, or other means of applying alcohol to human skin.

A cap 62 is removably attachable to the neck 18 of the bottle 12 which can be gripped by the user 52 for removing the cap 62 from the neck 18 of the bottle 12. The cap 62 has an uppermost wall 64 and a perimeter wall 66 extending downwardly from the uppermost wall 64; the perimeter wall 66 has an inside surface 68 that is threaded. Furthermore, the inside surface 68 threadably engages the outer surface 24 of the neck 18 when the cap 62 is removably attached to the neck 18 having the uppermost wall 64 resting upon the top end 26 of the neck 18 such that the uppermost wall 64 closes the opening 28 in the neck 18.

A stem 70 is coupled to and extends downwardly from the cap 62 such that the stem 70 extends into the interior space 16 of the bottom when the cap 62 is removably attached to the neck 18. The stem 70 has an upper end 72 and a lower end 74 and the stem 70 is elongated between the upper end 72 and the lower end 74. The upper end 72 is coupled to a bottom surface 76 of the uppermost wall 64 of the cap 62 having the stem 70 extending downwardly from the uppermost wall 64. Furthermore, the lower end 74 is spaced from the bottom surface 76 of the uppermost wall 64 such that the lower end 74 is submerged in the fluid finger treatment 48 when the cap 62 is removably attached to the neck 18.

A plurality of bristles 78 is coupled to the stem 70 such that the plurality of bristles 78 is submerged in the fluid finger treatment 48 when the cap 62 is removably attached to the neck 18. Furthermore, the plurality of bristles 78 is employed to apply the fluid finger treatment 48 to the user's fingertips 50. Each bristle 78 of the plurality of bristles 78 has a topmost end 80 which is coupled to the lower end 74 of the stem 70 and the plurality of bristles 78 is distributed over an entire area of the lower end 74 of the stem 70. Furthermore, each bristle 78 of the plurality of bristles 78 is comprised of a flexible material, including but not being limited to plastic or horsehair, such that each bristle 78 of the plurality of bristles 78 deforms when the user 52 wipes the plurality of bristles 78 on the user's fingertips 50 to enhance comfort for the user 52.

In use, the user 52 removes the cap 62 from the neck 18 of the bottle 12 and the user 52 employs the plurality of bristles 78 to apply the fluid finger treatment 48 to their fingertips 50 on the hand which the user 52 employs for fretting on the stringed instrument 56. The fluid finger treatment 48 hardens to form the artificial callus 54 when the fluid finger treatment 48 is applied to the user's fingertips 50. Furthermore, the artificial callus 54 on each fingertip 50 reduces the discomfort for the user 52 that is associated with depressing the strings 60 of the stringed instrument 56 with their fingertips 50. The user 52 wipes their fingertips 50 with an alcohol wipe 61, for example, to dissolve the artificial callus 54 on each fingertip 50 when the user 52 is finished playing the stringed instrument 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid finger protection device for forming an artificial callus on fingertips of a user to reduce pain associated with playing a stringed instrument, said device comprising:
a bottle having an outer wall defining an interior space of bottle, said bottle having a neck being in fluid communication with said interior space;
a fluid finger treatment being contained in said interior space of said bottle wherein said fluid finger treatment is configured to be applied to the user's fingertips, said fluid finger treatment comprising a curing solution wherein said fluid finger treatment is configured to harden when said fluid finger treatment is exposed to air such that said fluid finger treatment forms an artificial callus on the user's fingertips for reducing discomfort associated with playing the stringed instrument when said fluid finger treatment is applied to the user's fingertips;
a cap being removably attachable to said neck of said bottle wherein said cap is configured to be gripped by the user to remove said cap from said neck of said bottle;
a stem being coupled to and extending downwardly from said cap such that said stem extends into said interior space of said bottom when said cap is removably attached to said neck; and
a plurality of bristles, each bristle of said plurality of bristles being coupled to said stem such that said plurality of bristles is submerged in said fluid finger treatment when said cap is removably attached to said neck wherein said plurality of bristles is configured to apply said fluid finger treatment to the user's fingertips when the user removes said cap from said neck of said bottle.

2. The device according to claim 1, wherein:
said outer wall extends between a top wall of said bottle and a bottom wall of said bottle;
said neck extends upwardly from said top wall;
said neck has an outer surface being threaded;
said neck has a top end; and
said neck has an opening extending through said top end and into said interior space.

3. The device according to claim 1, wherein:
said outer wall of said bottle has a front side;
said bottle has word indicia being applied to said front side of said outer wall; and
said bottle has image indicia being applied to said front side of said outer wall.

4. The device according to claim 3, wherein said word indicia comprise the words “Riff” and “Relief” and “No Pain!”.

5. The device according to claim 4, wherein:
said bottle has a top wall and a bottom wall; and
said word “Riff” is positioned between said top wall and said bottom wall.

6. The device according to claim 4, wherein:
said outer wall has a first lateral side and a second lateral side; and
said word “Riff” is positioned closer to said first lateral side than said second lateral side.

7. The device according to claim 5, wherein said word “Relief” is positioned between said word “Riff” and said bottom wall.

8. The device according to claim 4, wherein:
said outer wall has a first lateral side and a second lateral side; and
said word “Relief” is positioned closer to said first lateral side than said second lateral side.

9. The device according to claim 7, wherein said words “No Pain!” are positioned between said word “Relief” and said bottom wall.

10. The device according to claim 4, wherein:
said outer wall has a first lateral side and a second lateral side; and
said words “No Pain!” are centrally located between first lateral side and said second lateral side.

11. The device according to claim 2, wherein said image indicia comprise an image of an electric guitar.

12. The device according to claim 3, wherein:
said outer wall has a first lateral side and a second lateral side; and
said image indicia are positioned between said word “Riff” and said second lateral side of said outer wall.

13. The device according to claim 1, wherein said fluid finger treatment comprises an alcohol soluble material wherein said fluid finger treatment is configured to dissolve when said fluid finger treatment is exposed to alcohol such that said fluid finger treatment is removed from the user's fingertips when the user wipes their fingertips with an alcohol wipe.

14. The device according to claim 2, wherein:
said cap has an uppermost wall and a perimeter wall extending downwardly from said uppermost wall;
said perimeter wall has an inside surface being threaded;
said inside surface threadably engages said outer surface of said neck when said cap is removably attached to said neck having said uppermost wall resting upon said top end of said neck such that said uppermost wall closes said opening in said neck.

15. The device according to claim 14, wherein:
said stem has an upper end and a lower end;
said stem is elongated between said upper end and said lower end;
said upper end is coupled to a bottom surface of said uppermost wall of said cap having said stem extending downwardly from said uppermost wall; and
said lower end is spaced from said bottom surface of said uppermost wall such that said lower end is submerged in said fluid finger treatment when said cap is removably attached to said neck.

16. The device according to claim 15, wherein:
each bristle of said plurality of bristles has a topmost end being coupled to said lower end of said stem; and
said plurality of bristles is distributed over an entire area of said lower end of said stem.

17. The device according to claim 1, wherein each bristle of said plurality of bristles is comprised of a flexible material wherein each bristle of said plurality of bristles is configured to deform when the user wipes said plurality of bristles on the user's fingertips to resist scratching the user's fingertips for enhancing comfort for the user.

18. A fluid finger protection device for forming an artificial callus on fingertips of a user to reduce pain associated with playing a stringed instrument, said device comprising:
a bottle having an outer wall defining an interior space of bottle, said bottle having a neck being in fluid communication with said interior space, said outer wall extending between a top wall of said bottle and a bottom wall of said bottle, said neck extending upwardly from said top wall, said neck having an outer surface being threaded, said neck having a top end, said neck having an opening extending through said top end and into said interior space, said outer wall having a front side, said bottle having word indicia being applied to said front side of said outer wall, said word indicia comprising the words “Riff” and “Relief” and “No Pain!”, said outer wall having a first lateral side and a second lateral side, said word “Riff” being positioned between said top wall and said bottom wall, said word “Riff” being positioned closer to said first lateral side than said second lateral side, said word “Relief” being positioned between said word “Riff” and said bottom wall, said word “Relief” being positioned closer to said first lateral side than said second lateral side, said words “No Pain!” being positioned between said word “Relief” and said bottom wall, said words “No Pain!” being centrally located between first lateral side and said second lateral side, said bottle having image indicia being applied to said front side of said outer wall, said image indicia comprising an image of an electric guitar, said image indicia being positioned between said word “Riff” and said second lateral side of said outer wall;
a fluid finger treatment being contained in said interior space of said bottle wherein said fluid finger treatment is configured to be applied to the user's fingertips, said fluid finger treatment comprising a curing solution wherein said fluid finger treatment is configured to harden when said fluid finger treatment is exposed to air such that said fluid finger treatment forms an artificial callus on the user's fingertips for reducing discomfort associated with playing the stringed instrument when said fluid finger treatment is applied to the user's fingertips, said fluid finger treatment comprising an alcohol soluble material wherein said fluid finger treatment is configured to dissolve when said fluid finger treatment is exposed to alcohol such that said fluid finger treatment is removed from the user's fingertips when the user wipes their fingertips with an alcohol wipe;
a cap being removably attachable to said neck of said bottle wherein said cap is configured to be gripped by the user to remove said cap from said neck of said bottle, said cap having an uppermost wall and a perimeter wall extending downwardly from said uppermost wall, said perimeter wall having an inside surface being threaded, said inside surface threadably engaging said outer surface of said neck when said cap is removably attached to said neck having said uppermost wall resting upon said top end of said neck such that said uppermost wall closes said opening in said neck;
a stem being coupled to and extending downwardly from said cap such that said stem extends into said interior space of said bottom when said cap is removably attached to said neck, said stem having an upper end and a lower end, said stem being elongated between said upper end and said lower end, said upper end being coupled to a bottom surface of said uppermost wall of said cap having said stem extending downwardly from said uppermost wall, said lower end being spaced from said bottom surface of said uppermost wall such that said lower end is submerged in said fluid finger treatment when said cap is removably attached to said neck; and
a plurality of bristles, each bristle of said plurality of bristles being coupled to said stem such that said plurality of bristles is submerged in said fluid finger treatment when said cap is removably attached to said neck wherein said plurality of bristles is configured to apply said fluid finger treatment to the user's fingertips, each bristle of said plurality of bristles having a topmost end being coupled to said lower end of said stem, said plurality of bristles being distributed over an entire area of said lower end of said stem, each bristle of said plurality of bristles being comprised of a flexible material wherein each bristle of said plurality of bristles is configured to deform when the user wipes said plurality of bristles on the user's fingertips to resist scratching the user's fingertips for enhancing comfort for the user.

19. A method of forming an artificial callus on a fingertip of a user, the steps of the method comprising:
removing a cap from a bottle which contains a fluid finger treatment, said cap having a stem being coupled to and extending away from said cap, said stem having a plurality of bristles each coupled to a distal end of said stem with respect to said cap;
employing said plurality of bristles to brush said fluid finger treatment onto each fingertip of a fretting hand of a user who will be playing a stringed instrument;
waiting until said fluid finger treatment which is applied to each fingertip dries to form an artificial callus on each fingertip;
fretting said stringed instrument with each fingertip on which said artificial callus has formed; and
wiping each fingertip with alcohol thereby dissolving said artificial callus on each fingertip when the user is finished playing said stringed instrument.
